(19) United States
(12) Patent Application Publication
(10) Pub. No.: US 2008/0119146 A1
(43) Pub. Date: May 22, 2008

(54) DEVICE FOR MONITORING TRANSMISSION ANTENNAE OF ELECTROMAGNETIC DETECTION SYSTEMS

(75) Inventors: Francois Schmidt, Millery (FR); Daniel Heyden, Toussieu (FR)

Correspondence Address: CANTOR COLBURN, LLP, 20 Church Street, 22nd Floor, Hartford, CT, 06103, US

(73) Assignee: EXAQT S.A. DE CV, Col. Las Aguilas (MX)

(21) Appl. No.: 11/936,371

(22) Filed: Nov. 7, 2007

Related U.S. Application Data
(63) Continuation of application No. 10/499,267, filed on Dec. 17, 2004, now abandoned.

(30) Foreign Application Priority Data
Dec. 21, 2001 (FR) FR0116766

(51) Int. Cl. H01Q 11/12

(52) U.S. Cl. 455/127.1

(57) ABSTRACT

The invention concerns electromagnetic detection systems designed to detect stolen objects, and comprising at least a transmission antenna and at least a reception antenna, the or each transmission antenna being powered by a power amplifier. The device consists of at least a transmission antenna (4) proper, not frequency-tuned, at least an on/off simplified power amplifier (6) of H-bridge or half-bridge or quarter-bridge type, the directly coupled to said amplifier (6), and at least an electronic powering circuit, whereof the output is connected to the amplifier.

The present invention relates, in a general manner, to electromagnetic detection systems, such as systems providing for the detection of objects, for example of stolen objects. More particularly, this invention is concerned with a device for driving the transmission antennas, in such electromagnetic detection systems.

Detection systems which utilize the particular characteristics of certain magnetic materials are used in various sectors to inform the user of the presence of such materials in a specific space volume for each type of system.

The preferential sectors for the use of such systems are, for example, anti-theft protection in shops and warehouses, authentication of information media and products, detection of surgical products forgotten inside the body of patients after an operation, and any other sector in which one seeks to measure small variations inside an intense electromagnetic field.

The electromagnetic detection systems known at present use the following principle:
A first antenna or, usually, a set consisting of several elementary antennas, is fed from an electronic power amplifier which forces the circulation of an alternating current in the antenna. This current creates an alternating electromagnetic field in a volume of space characteristic of the shape of the antenna and with an intensity proportional to the value of the current. This antenna is called the transmission antenna.
A second antenna, called the reception antenna, or, more generally, a set of several elementary antennas, is the seat of an induced current dependent on the shape of this antenna, and variations of the electromagnetic flux which passes through it.
A compensation, balancing and filtering system, differing according to the various systems, makes it possible to render the reception antenna and its associated amplifier circuits sensitive to the presence of elements of particular magnetic materials, when these elements are excited by the transmission field. A great diversity of such “markers” incorporating various types of magnetic materials is used.
A calculation unit, usually electronic, drives the transmission current, shapes the reception signals and evaluates a diagnosis of presence or absence of “marker”; it also provides for the links between the systems and the external devices.

Contemporary electromagnetic detection systems practically all use a tuned transmission circuit, that is to say the transmission antenna is associated with capacitive, inductive and resistive components which create an overvoltage for the characteristic frequency or frequencies of each system. The tuned transmission circuits are useful, to increase the current in the transmission antennas without using any power amplifier of overly large size.

On the other hand, as in any tuned circuit exhibiting a large overvoltage factor, a relatively long time is required here in order to modify the amplitude or the phase of the alternating current circulating around the antennas. Moreover, if one wishes to modify the transmission frequency, provision must be made to modify the tuning of the tuned circuit, this being expensive since one is dealing with a power circuit in which large currents circulate and which uses expensive and voluminous components; this function is absolutely indispensable in numerous systems since it must be possible to synchronize several devices exactly on the same frequency so that they do not disturb one another when they are placed in one and the same environment. The modification of the phase of the current makes it possible, for its part, to modify the preferential directions of the electromagnetic fields emitted and thus to detect “markers” whose direction of maximum sensitivity is variable.

The present invention is aimed at eliminating all of these drawbacks, and its goal is therefore to greatly simplify the “transmission” part in respect of electromagnetic detection systems of the kind concerned here, thus procuring a large cost saving, while giving the possibility of implementing very easily, and with no expensive ancillary device, functions which are desired like the possibility of instantaneously driving the frequencies, the amplitudes and the phases of the currents circulating around several antenna elements, doing so by proposing direct driving of the transmission antenna, with no tuning element between the power amplifier and the antenna.

Accordingly, a subject of the invention is essentially a device for driving the transmission antennas of electromagnetic detection systems, in a continuous-transmission detection system comprising at least one transmission antenna and at least one reception antenna, the or each transmission antenna being fed by an electronic power amplifier, and the or each reception antenna being linked up to a compensation circuit, the device being composed principally, and in combination:
of at least one transmission antenna element proper, not frequency-tuned,
of at least one simplified power amplifier, operating in “on or off” mode, of the “H-bridge” or “half-bridge” or “quarter-bridge” kind, the or each transmission antenna element being coupled directly to this power amplifier, and
of at least one electronic feed circuit, whose output is connected to the power amplifier.

Thus, the idea on which the invention is based consists in coupling the transmission antenna directly to its power amplifier, with no matching components such as transformers, inductors or capacitors, the amplifier preferably being of the so-called “H-bridge” type, but possibly also using the so-called “half-bridge”, or even “quarter-bridge” topology, as specified hereinafter. In all cases, one is dealing with a simplified amplifier operating in “on or off” mode, controlled directly by signals of digital type, that is to say possessing a “zero” level or a “one” level.

The direct coupling between the transmission antenna and the amplifier enables the frequency of the electromagnetic field emitted by the antenna to be made to vary rapidly, and for the phase of the electromagnetic field emitted by this antenna to also be made to vary rapidly.

Insofar as the transmission antenna and the amplifier are fed by an electronic feed circuit of the “power factor corrector” type, it is also possible for the amplitude of the electromagnetic field emitted by the antenna to be made to vary rapidly by varying the electric voltage supplied to the power amplifier by such a feed circuit.

Here, these functionalities assume all their efficacity, since the antenna is not tuned, and they enable the reliability and the sensitivity of detection to be considerably improved.

In a preferred embodiment of the invention, the or each transmission amplifier is an amplifier of the “H-bridge” kind, with four branches each comprising an active switching element and a passive recovery element, mounted in parallel, with four branches being linked to power feeds, and their switching elements also being linked, by way of control stages, to an electronic stage for shaping control signals.

In another advantageous embodiment of the invention, the or each transmission amplifier is an amplifier of the “half-H-bridge” kind, with four branches, two of which comprise an active switching element and a passive recovery element, mounted in parallel, while the other two branches are made with at least one capacitor and/or with at least one power feed, the switching elements of the first two branches being linked, by way of at least one control stage, to an electronic stage for shaping the control signals.

In a third embodiment, the or each transmission amplifier is an amplifier of the “quarter-H-bridge” kind, with four branches, only one of which comprises an active switching element and a passive recovery element, mounted in parallel, while the other branches are made with at least one capacitor and/or with at least one power feed, the switching element of the first branch being linked, by way of a control stage, to an electronic stage for shaping the control signals. However, in this last embodiment, the performance of the amplifier is degraded, since the single active element can drive the current in the transmission antenna in one direction only.

It should also be noted that the capacitors used in the passive branches of the H-bridges, for the “half-bridge” or “quarter-bridge” embodiments, have as role to supply points of return of the current of the transmission antenna, with matched electric voltages; these capacitors have, in general, a capacitance of large value and they are not used here to tune the circuit which they make up together with the inductor of the associated antenna element.

According to another aspect of the invention, the or each power amplifier is provided so as to cause the circulation, in the transmission antenna element directly coupled to this amplifier, of a current of essentially “triangular” shape, the voltage in the same transmission antenna element possessing the form of a “square” signal. Accordingly, the transmission amplifiers are themselves advantageously driven by “square” input signals of maximum amplitude, thereby allowing extreme simplification of their design, and making it possible to reduce the number of components and to decrease the thermal dissipation and also the surface area of the thermal dissipaters used to remove the heat produced.

As a function of the variations of the “square” signal for driving the amplifiers, the current circulating in the or each transmission antenna element, hence the electromagnetic field emitted by this antenna element, is frequency-modulated and/or phase-modulated and/or amplitude-modulated, being so according to any desired law of variation for example sinusoidal, triangular, square or random. It will be noted that increasing the transmission frequency makes it possible to decrease the amplitude of the electromagnetic field emitted, when it is not desirable or not possible to reduce the electric voltage supplied to the amplifier by the feed.

According to another characteristic of the invention, the or each compensation circuit, receiving the signal emanating from a reception antenna element, comprises a matching and amplifying circuit, capacitors, inductors and switches, that are designed to weaken the transient signals created in the reception antenna element, in particular during voltage reversals when the amplifier is switched, and also during reversals of current in the antenna, to compensate for the effects of the flow of the current in the amplifier, which occurs alternately in the active switching element or elements and in the passive recovery element or elements. The components used to carry out the compensation function may also carry out the function of balancing between several reception antenna elements, so as to attenuate the signals created in the reception antenna by the proximity of the transmission antenna and of magnetic materials. The solution of a compensation circuit, interposed in the reception path, is more effective and less expensive than matching stubs made on the transmission amplifier, for example by multiplying up the active switching elements or by using complementary bias feeds for the active switching elements and the passive recovery elements.

The invention will be better understood with the aid of the description which follows, with reference to the appended diagrammatic drawing representing, by way of examples, a few forms of execution of this device for the driving of the transmission antennas of electromagnetic detection systems:

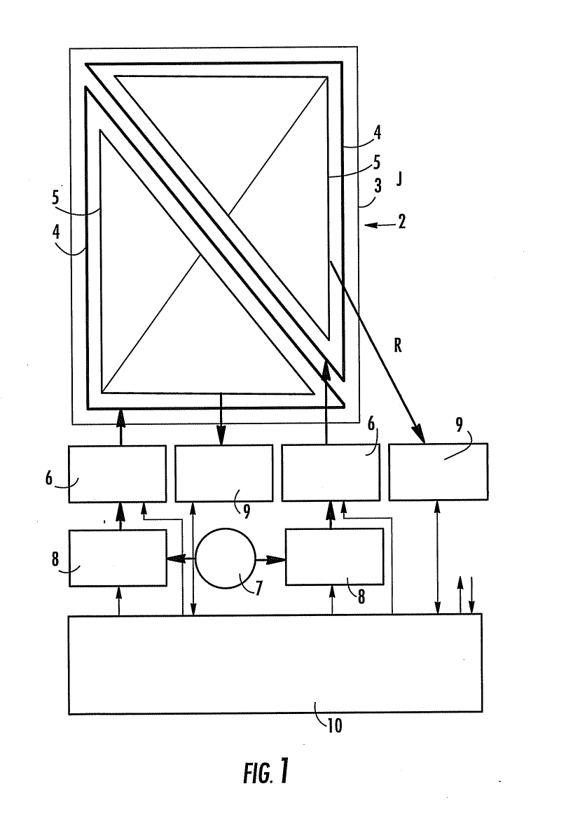

FIG. 1 is a general schematic diagram of a system of detection antennas, with the associated electronic circuits;

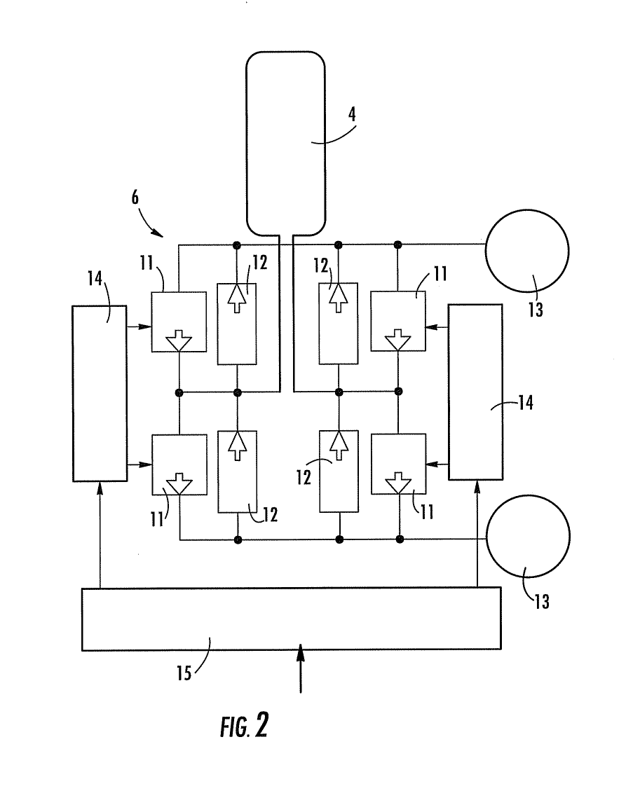

FIG. 2 represents a first embodiment of the invention, with amplifier of the “H-bridge” kind linked to a transmission antenna element:

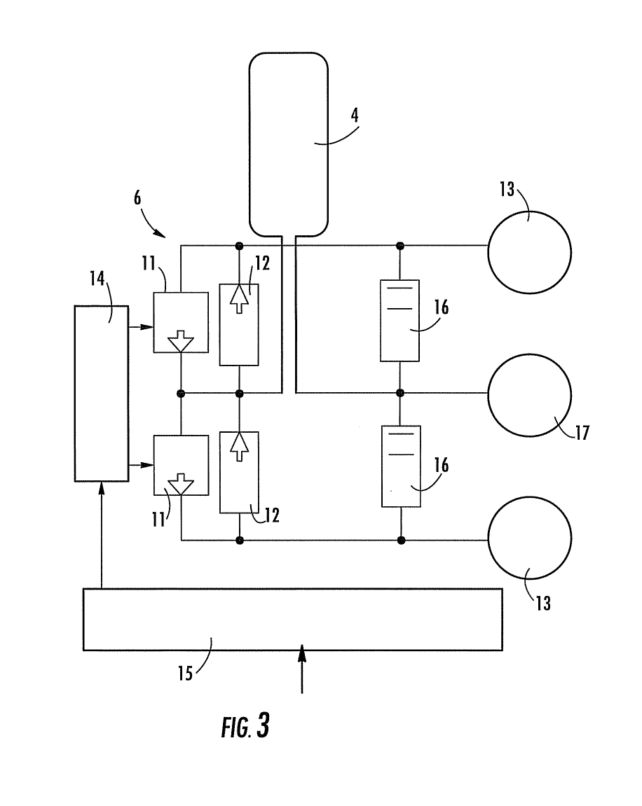

FIG. 3 represents a second embodiment of the invention, with amplifier of the “half-bridge” kind linked to a transmission antenna element;

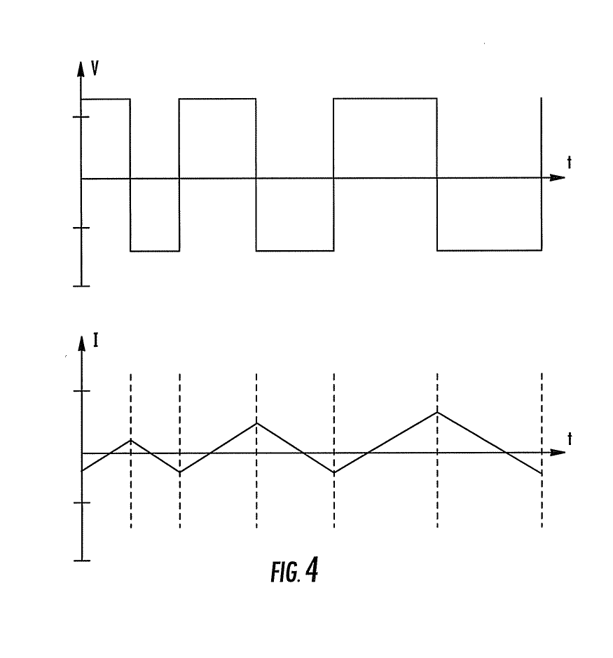

FIG. 4 is a chart illustrating exemplary shapes of current and of voltage in a transmission antenna element;

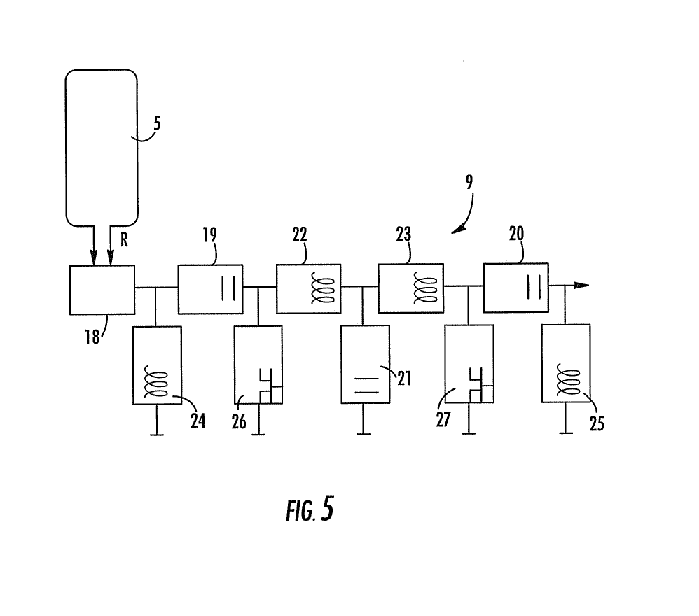

FIG. 5 represents, in a greater detail, an exemplary embodiment of the compensation circuit.

FIG. 1 shows a typical antenna of a system for the electromagnetic detection of stolen objects, the antenna designated overall by the label 2 comprising a mechanical assembly 3, supporting the coils of the transmission and reception antennas. The transmission antennas here comprise two transmission antenna elements 4, while the reception antennas comprise two reception antenna elements 5. The two transmission antenna elements 4, just like the two reception antenna elements 5, form two balanced branches, for example of triangular shape, which compensate one another.

For each of the two transmission antenna elements 4, there is provided an amplifier, i.e. in the example illustrated two amplifiers 6. The output of each amplifier 6 is connected electrically to the corresponding transmission antenna element 4.

The system possesses a general power supply 7, from the AC power distribution network, or from any other electrical power source, such as cells, batteries or solar panels. The general supply 7 serves two particular power supplies 8, respectively associated with the two transmission amplifiers 6. The output of each particular supply 8 is connected to the corresponding transmission amplifier 6.

With each reception antenna element 5 is associated a compensation circuit 9.

The system further comprises an electronic processing unit 10, which carries out the following functions (in conjunction with the other components):
The unit 10 dispatches control signals to the amplifiers 6. After amplification, these signals define the temporal shape of the signal transmitted by the transmission antenna elements 4.
The unit 10 dispatches driving signals to the supplies 8, to control their output voltage which feeds the amplifiers 6 and defines the amplitude of the currents circulating around the transmission antenna elements 4, hence the intensity of the electromagnetic fields transmitted by these antenna elements 4.
The unit 10 drives the compensation circuits 9 connected to the reception antenna elements 5, and receives the compensated signals emanating from these circuits 10, on which signals it performs the processing making it possible to formulate the decision regarding detection of the presence of “markers” in the field of the antenna 2.
Finally, the unit 10 possesses (as symbolized by arrows on the right of FIG. 1) interfaces for transmitting or receiving information from the peripheral systems.

FIG. 2 represents, in detail, an amplifier 6 associated with a transmission antenna element 4, the amplifier 6 being of the “H-bridge” kind.

Each of the four branches of such an “H-bridge” comprises an active switching element 11 and a passive recovery element 12, mounted in parallel, the arrows indicating the direction of flow of the current in these elements 11 and 12. The active switching element 11 is for example a bipolar or field-effect transistor, a thyristor or an IGBT transistor. The passive recovery element 12 is for example a diode.

Supplies 13 provide the active switching elements 11 with the necessary power for the appropriate voltage. These supplies 13 also absorb the currents routed by the passive recovery elements 12.

Electronic control stages 14 provide for the control of the active switching elements 11, each stage 14 being associated with a pair of switching elements 11. The control stage 14 turns on a switching element 11 of the pair concerned, at the same time as it isolates the other switching element 11, doing so alternately for one element 11 (such as that at the top) and the other element 11 (such as that at the bottom). This control stage 14 may be embodied with discrete electronic components, or with specialized integrated circuits.

Finally, the amplifier 6 of the “H-bridge” kind comprises an electronic stage 15 for shaping the control signals. The stage 15 receives the signals originating from the processing unit 10 (FIG. 1), and it adapts them so that they can be used by the control stages 14.

The amplifier 6 of the “H-bridge” kind, made up as just described, is coupled directly to the associated transmission antenna element 4.

FIG. 3, in which the elements corresponding to those of FIG. 2 are designated by the same labels, shows another embodiment of the amplifier 6 associated with a transmission antenna element 4. Here we are dealing with an amplifier of the “half-bridge” kind, again coupled directly to the transmission antenna element 4. Two branches of the previously described H-bridge of FIG. 2 are here replaced by one or more capacitors 16, usable alone or in association with one or more complementary supplies, such as that indicated at 17.

During the operation of the antenna 2, having regard to the mode of operation of the complete “H-bridge” or of the “half-bridge”, as the case may be, constituting the transmission amplifier 6, the current I in the transmission antenna element 4 possesses, as a function of time t, the form illustrated in the lower part of FIG. 4. The current I is here, fundamentally, of “triangular” shape. As far as the voltage V in the same transmission antenna element 4 is concerned, this voltage possesses the form of a “square” signal, as illustrated in the upper part of FIG. 4, this presupposing that the transmission amplifier 6 is driven on its input by a likewise “square” signal. As FIG. 4 also illustrates, this “square” signal can be frequency-modulated.

It will also be noted that the complete “H-bridge” version (FIG. 2) of the transmission amplifier 6 is, for example, well suited to a device fed by a 110 volt AC network, whereas the “half-bridge” version (FIG. 3) is advantageous in the case of a 220 volt AC network; specifically, the “half-bridge” provides the transmission antenna element 4 with an AC voltage whose value is equal to half that provided by the complete “H-bridge”.

Finally, FIG. 5 represents the compensation circuit 9, associated with a reception antenna element 5. The compensation circuit 9 comprises an impedance-matching and amplifying circuit 18, capacitors 19, 20 and 21, inductors 22, 23, 24 and 25, and switches 26 and 27, the latter being controlled by the electronic processing unit 10 (FIG. 1), in synchronism with the voltages V and the currents I (FIG. 4) of the transmission antenna elements 4. The compensation circuit 9, thus made up, provides for the shaping of the reception signals R, in particular so as to reduce the phenomenon of disturbance of the globally “triangular” form of the current I by a small voltage step at the instants at which the direction of this current reverses, the “H-bridge” then going from operation driven by the switching elements 11 to operation driven by the recovery elements 12 (FIGS. 2 and 3). The compensation circuit 9 thus ensures a filtering which removes the transients appearing in the reception signal, mainly during reversals of the direction of the current I. The compensation circuit 9 also intervenes during reversals of the direction of variation of the current I, that is to say when crossing through the maxima and minima of the “triangle” (FIG. 4). Finally, the compensation circuit 9 carries out a balancing to compensate for the residual imbalances in the reception signal R, between the positive and negative half-waves; these imbalances possessing an internal origin, on account of the system construction tolerances, and also an extreme origin, for example on account of dissymmetries of electromagnetic impedance of the physical environment of the antenna 2.

The electromagnetic detection system described above is applicable not only to the detection of stolen objects, but also to the detection of other objects and, more generally, to any detection based on small variations inside an intense electromagnetic field.

A particular application of the invention is the detection of the presence of a material liable to be in more or less noisy vibration when it is subjected to the electromagnetic field emitted by the system, this being the case, for example, for magnetostrictive materials. The increase in the transmission frequency is then used to place this frequency in the inaudible region, that is to say typically above 20 kHz, so as to limit possible acoustic nuisance. The presence of materials liable to enter thus into vibration may be detected automatically, for example by means of a microphone sensitive to the acoustic noise generated by the material in question; in case of detection, the system then passes automatically into a mode of transmission at high frequency. For the remainder, the system may be the same as that used to detect the markers with a view to the detection of stolen objects, the electronic processing unit using, however, specific software for this additional function.

One would not be departing from the scope of the invention, as defined in the appended claims:
by using, in a variant, a transmission amplifier of the so-called “quarter-bridge” kind, which uses only an active switching element and a passive recovery element, in a branch, all the other branches of the bridge being made up of capacitors or feeds;
by modifying the details of the electronic circuits;
by modifying the shape, the disposition and the number of the transmission antenna elements and of the reception antenna elements;
by driving the device according to any desired mode, in particular by varying the frequency, or the phase, or the amplitude of the electromagnetic field emitted by the antenna elements, doing so according to any law of variation, by modifying or by adapting the triangular shape of the current which passes through the transmission antenna element or elements;
in the case of a system comprising two or more transmission antenna elements, each coupled directly to an amplifier, by driving each transmission amplifier by a different signal from the others, the assembly thus making it possible to create a particular spatial configuration of the electromagnetic field emitted, and to vary this spatial configuration rapidly.

1.-7. (canceled)

8. A device for driving transmission antennas of electromagnetic detection systems, in a continuous-transmission detection system comprising at least one transmission antenna and at least one reception antenna, the or each transmission antenna being fed by an electronic power amplifier, and the or each reception antenna being linked up to a compensation circuit, the device comprising:
at least one transmission antenna element proper, not frequency-tuned,
at least one simplified power amplifier, operating in “on or off” mode, which is an “H-bridge” or “half-bridge” or “quarter-bridge” amplifier, the transmission antenna element being coupled directly to the power amplifier, and
at least one electronic feed circuit, whose output is connected to the power amplifier,
wherein said H-bridge, or said half bridge, or said quarter bridge includes four branches, at least one of said four branches comprising an active switching element and a passive recovery element mounted in parallel.

9. The device as claimed in claim 8, wherein the transmission amplifier is the “H-bridge” amplifier, with the four branches each comprising the active switching element and the passive recovery element, mounted in parallel, said four branches being linked to power feeds, and the switching elements being linked, by way of control stages, to an electronic stage for shaping control signals.

10. The device as claimed in claim 8, wherein the amplifier is the “half-H-bridge” amplifier, with the four branches, two of said four branches comprising the active switching element and the passive recovery element, mounted in parallel, while the other two branches are made with at least one capacitor and/or with at least one power feed, the switching elements of the first two branches being linked, by way of at least one control stage to an electronic stage for shaping the control signals.

11. The device claimed in claim 8, wherein the amplifier is the “quarter-H-bridge” amplifier, with the four branches, only one branch of said four branches comprising the active switching element and the passive recovery element, mounted in parallel, while the other branches are made with at least one capacitor and/or with at least one power feed, the switching element of the first branch being linked, by way of a control stage, to an electronic stage for shaping the control signals.

12. The device as claimed in claim 8, wherein the power amplifier is provided so as to cause circulation in the transmission antenna element directly coupled to the amplifier of a current of essentially “triangular” shape, a voltage in the same transmission antenna element possessing a form of a “square” signal.

13. The device as claimed in claim 12, wherein the current circulating in the transmission antenna element forms an electromagnetic field emitted by the antenna element which is frequency-modulated and/or phase-modulated and/or amplitude-modulated.

14. The device as claimed claim 8, wherein the compensation circuit receives a signal emanating from a reception antenna element, the circuit comprising a matching and amplifying circuit, capacitors, inductors, and switches, that are designed to weaken transient signals created in the reception antenna element.
